(19) United States
(12) Patent Application Publication
(10) Pub. No.: US 2011/0126052 A1
(43) Pub. Date: May 26, 2011

(54) Generation of Test Information for Testing a Circuit

(76) Inventors: Bhavesh Mistry, Toronto (CA); Patrick Noonan, Windham, ME (US); Vincent Accardi, Toronto (CA)

(21) Appl. No.: 12/769,726

(22) Filed: Apr. 29, 2010

Related U.S. Application Data
(60) Provisional application No. 61/263,555, filed on Nov. 23, 2009.

(51) Int. Cl. G06F 11/00; G06F 17/50

(52) U.S. Cl. 714/33; 703/14; 714/E11.02

(57) ABSTRACT

System and method for generating test information for a physical circuit. A virtual circuit may be generated. First user input specifying one or more test conditions and/or instrument settings for the virtual circuit may be received. In response to the first user input, first test information may be generated. The first test information may be configured for use in performing one or more virtual tests on the virtual circuit. Second user input requesting that second test information be generated based on the first test information may be received. The second test information may be automatically generated based on the first test information in response to the second user input, without user input specifying the one or more test conditions and/or instrument settings. The second test information may be configured for use in performing one or more physical tests on a physical circuit corresponding to the virtual circuit.

### PRIORITY CLAIM

This application claims benefit of priority to provisional Application No. 61/263,555, filed Nov. 23, 2009, titled “Generation of Test Information for Testing a Circuit”, whose inventors are Bhavesh Mistry, and Vincent Accardi, which is hereby incorporated by reference in its entirety as though fully and completely set forth herein.

### CROSS-REFERENCE TO RELATED PATENTS

U.S. Pat. No. 6,577,981, titled “Test Executive System and Method Including Process Models for Improved Configurability”, whose inventors are James Grey and Eric Crank, is hereby incorporated by reference as though fully and completely set forth herein.

U.S. patent application Ser. No. 11/609,928, titled “Coupling a Virtual Instrument to a Circuit Diagram”, whose inventors are Kyle P. Gupton, Rajesh S. Vaidya, and Lingyun Pan, is hereby incorporated by reference as though fully and completely set forth herein.

### FIELD OF THE INVENTION

The present invention relates to circuit design, and more specifically to generating test information for testing a circuit.

### DESCRIPTION OF THE RELATED ART

Electronics and electronic systems which utilize circuits are ubiquitous. Designing a circuit for a particular application is, however, a non-trivial process. Circuit design traditionally includes a series of sequential steps. For example, a typical design process might include generating a concept of what a circuit should do and determining desirable requirement(s) for the circuit, designing the circuit (e.g., generating an electronic schematic/circuit diagram), laying out/prototyping the circuit, testing the circuit, and eventually manufacturing the circuit. Furthermore, it is often the case that the design process may include going back to a previous step e.g., if a design improvement becomes apparent, or if one or more problems are identified that require reconsideration or modification of previous steps. Even though such a sequential series of steps typically leads to this potentially inefficient back-and-forth movement between steps of the design process, this series approach has traditionally been necessary because, for example, it has not been possible to develop test conditions and applications until after a circuit has been prototyped. Accordingly, improvements in the field of circuit design and test are desirable.

### SUMMARY OF THE INVENTION

Various embodiments are presented of a system and method for generating test information for a physical circuit. The method may be implemented by a computer system, e.g., including one or more processors and a computer readable memory medium which stores program instructions executable by the one or more processors to implement the method. Embodiments are also contemplated which include a computer readable memory medium which stores program instructions executable by a computer system to implement the method.

A virtual circuit may be generated. The virtual circuit may simulate characteristics of a physical circuit. First user input specifying one or more test conditions and/or instrument settings for the virtual circuit may be received. In response to the first user input, first test information may be generated. The first test information may include the one or more test conditions, virtual stiumulus, and/or instrument settings. The first test information may be configured for use in performing one or more virtual tests on the virtual circuit. In some embodiments, the method may further include performing the one or more virtual tests on the virtual circuit using the first test information. For example, the one or more virtual tests may be performed by one or more virtual instruments utilizing the one or more test conditions and/or instrument settings.

Second user input may be received. The second user input may request that second test information be generated based on the first test information. In response to the second user input, second test information may be automatically generated based on the first test information. The second test information may also include the one or more test conditions and/or instrument settings. The second test information may be automatically generated without user input specifying the one or more test conditions and/or instrument settings.

The second test information may be configured for use in performing one or more physical tests on a physical circuit corresponding to the virtual circuit. In some embodiments, at least a portion of the second test information may be generated in a format configured for use by a test executive engine. For example, embodiments are contemplated in which at least a portion of the second test information is generated in automatic test mark-up language (ATML). Embodiments are also contemplated in which the second test information is generated according to various other formats. According to various embodiments, the second test information may include a test sequence, e.g., including a plurality of test steps, information identifying one or more locations in the physical circuit at which the one or more physical tests are to be performed, test type information for one or more test steps, test limit information for one or more test steps, and/or any of various other test related information. The second test information may be used to automatically configure one or more instruments to perform the one or more physical tests on the physical circuit corresponding to the virtual circuit according to the one or more test conditions, instrument settings, and/or any other test related information included in the second test information.

In some embodiments, the method may further include performing the one or more physical tests on the physical circuit corresponding to the virtual circuit using the second test information. For example, the one or more physical tests may be performed by one or more physical instruments utilizing the one or more test conditions and/or instrument settings.

Thus, the method may allow a user to generate test steps and test sequences for a virtual circuit which correspond to real world test steps and test sequences. Since such modeling of test steps and test sequences does not require that a physical prototype corresponding to the virtual circuit yet exist, and since the method allows for test information which can be used to perform corresponding real world test steps and test sequences on a physical analog to the virtual circuit to be automatically generated based on the user's test steps and test sequences for the virtual circuit, the method may allow for test steps and test sequences to be developed for a circuit in parallel with or even before prototyping of the circuit. This increased parallelism in the circuit design process provides a significant advantage over the prior art techniques which require a more serial approach to circuit design.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an exemplary computer system that could be used to implement the present disclosure according to one embodiment;

FIG. 2 illustrates an exemplary instrumentation control system that could be used to implement the present disclosure according to one embodiment;

FIG. 3 is a block diagram illustrating one implementation of a computer system that could be used to implement the present disclosure according to one embodiment;

FIGS. 4A-4B are diagrams illustrating design flow of a circuit design process according to one embodiment;

FIG. 5 is a flowchart diagram illustrating a method for generating test information for testing a circuit according to one embodiment;

FIGS. 6-7 illustrate serial and parallel circuit design flow respectively, and exemplary tools that could be used for each step, according to one embodiment;

FIG. 8 shows an exemplary implementation of a circuit design process including automatic test information generation according to one embodiment;

FIGS. 9-10 are exemplary screenshots illustrating aspects of a possible implementation of automatically generating test information according to one embodiment; and

FIG. 11 illustrates an architecture of a test executive and associated tools according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms:

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a PROM, EPROM, EEPROM, flash memory, or magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Circuit—A “circuit” or “circuit device” as used herein has its ordinary and accepted meaning in the art, and at least includes electronic components and connections between the components. Examples of circuits and circuit devices may include printed circuit boards (PCBs), integrated circuits (ICs) including system on chips (SoCs), and/or any of various semiconductor devices.

Circuit Diagram—The term “circuit diagram” as used herein has its ordinary and accepted meaning in the art, and at least includes a representation of a circuit including components of the circuit and connections between the components. A circuit diagram may alternatively be referred to as a circuit schematic, an electronic schematic, or an electrical diagram, according to various embodiments.

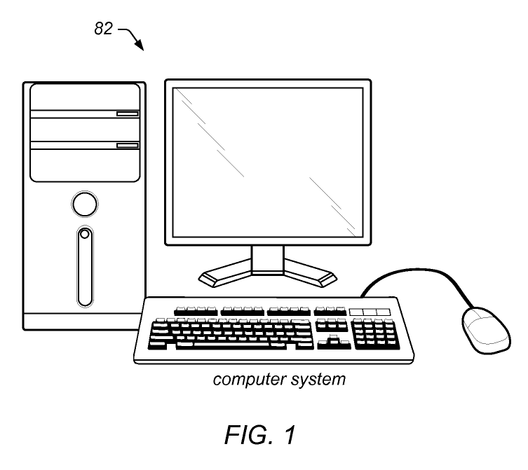

### FIG. 1—Computer System

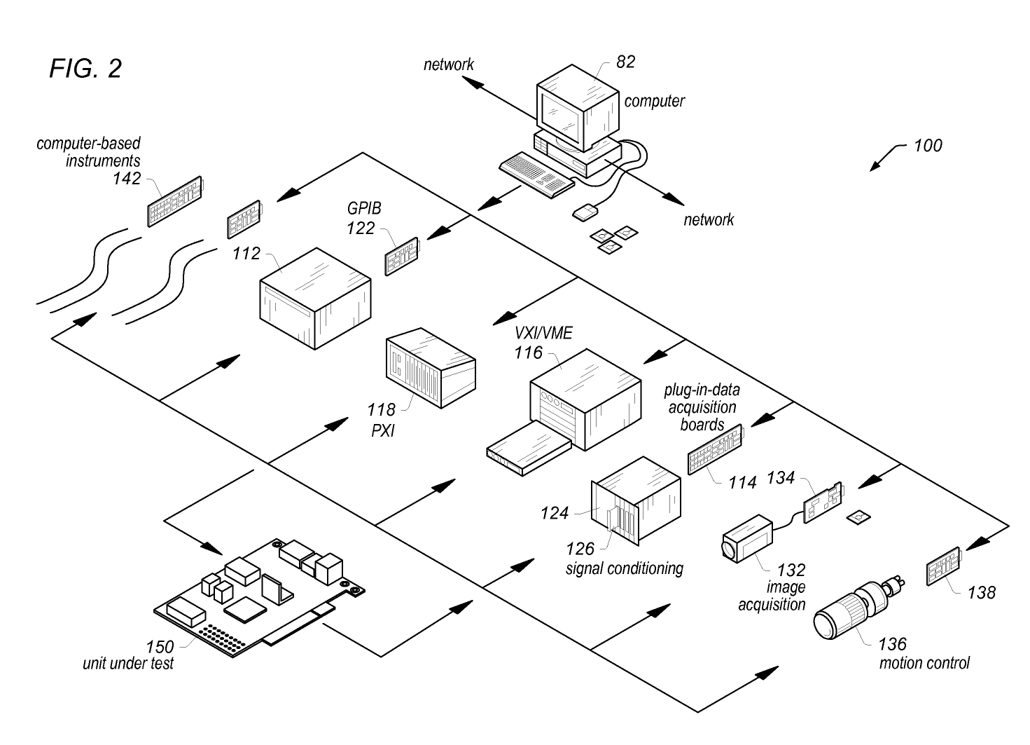

FIG. 1 illustrates a computer system 82 which may be configured to implement the present disclosure according to some embodiments. As shown in FIG. 1, the computer system 82 may include one or more user input devices, such as a keyboard, mouse, and/or display device. The computer system 82 may include at least one memory medium on which one or more computer programs or software components according to one embodiment of the present invention may be stored. For example, the memory medium may store one or more programs which are executable to perform various circuit design, simulation, and/or testing functions. In some embodiments, the memory medium may store one or more programs which are executable to control an instrumentation system (such as shown in and described with respect to FIG. 2). The memory medium may also store operating system software, as well as other software for operation of the computer system.

### FIG. 2—Instrumentation Control System

FIG. 2 illustrates an exemplary instrumentation control system 100 which may implement embodiments of the present disclosure. According to various embodiments, the instrumentation control system 100 may be involved with performing test and/or measurement functions; controlling and/or modeling instrumentation or industrial automation hardware; modeling and simulation functions, e.g., modeling or simulating a device or product being developed or tested, etc. In particular, embodiments are contemplated in which instrumentation control system is used to perform one or more tests (e.g., using any of the various instruments in the instrumentation control system 100) on a unit under test (UUT) 150, which may include a physical circuit device. However, it is noted that embodiments of the present invention can be used for a plethora of applications and is not limited to the above applications. In other words, applications discussed in the present description are exemplary only, and embodiments of the present invention may be used in any of various types of systems.

The system 100 may include a host computer 82 which couples to one or more instruments. The host computer 82 may include a CPU, a display screen, memory, and one or more input devices such as a mouse or keyboard as shown. The computer 82 may operate with the one or more instruments to analyze, measure or control UUT 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. In some systems, one or more instruments may be configurable (or even re-configurable) by a computer system. For example, embodiments are contemplated in which one or more instruments include one or more programmable hardware elements, which may be configured (e.g., using a graphical program created using LabVIEW™ by National Instruments Corporation, or by any other means) to implement a particular function.

The computer system may couple to and operate with one or more of these instruments. The instruments may be coupled to the UUT 150, or may be coupled to receive field signals, typically generated by transducers. In some embodiments, one or more of the various devices shown in FIG. 2 may couple to each other over a network, such as the Internet.

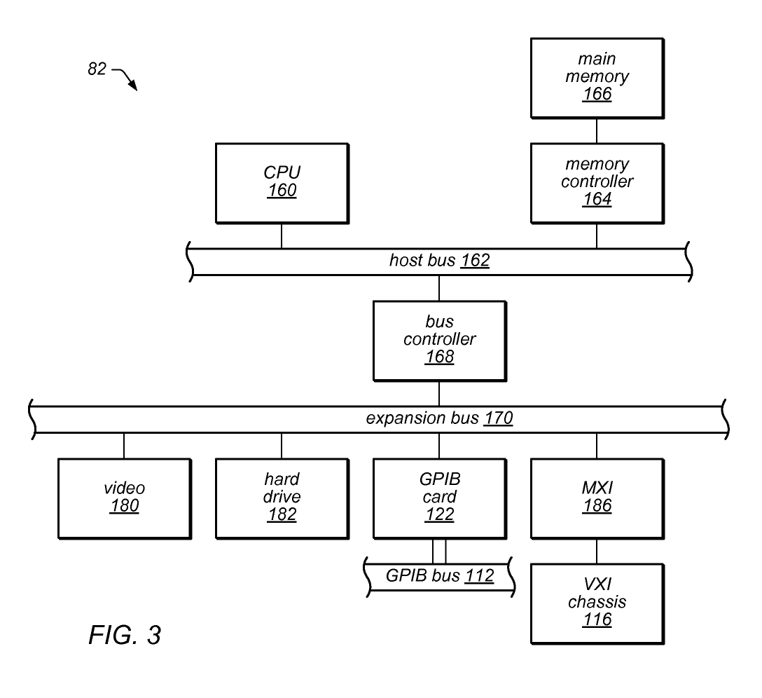

### FIG. 3—Computer System Block Diagram

FIG. 3 is a block diagram representing one embodiment of the computer system 82 illustrated in FIGS. 1 and 2. It is noted that any type of computer system configuration or architecture can be used as desired, and FIG. 3 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store the one or more programs executable to implement embodiments of the disclosure. The main memory may also store operating system software, as well as other software for operation of the computer system.

The host bus 162 may be coupled to an expansion or input/output bus 170 by means of a bus controller 168 or bus bridge logic. The expansion bus 170 may be a PCI (Peripheral Component Interconnect) expansion bus, although other bus types can be used. The expansion bus 170 includes slots by which various devices (such as those described above with respect to the instrumentation control system of FIG. 2) couple to the computer system 82. The computer 82 further comprises a video display subsystem 180 and hard drive 182 coupled to the expansion bus 170. The computer 82 may also comprise a GPIB card 122 coupled to a GPIB bus 112, and/or an MXI device 186 coupled to a VXI chassis 116.

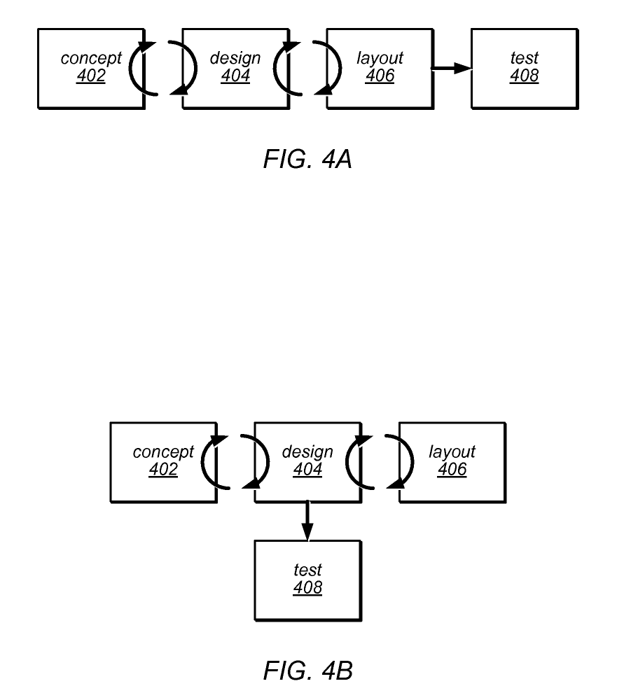

### FIGS. 4A and 4B—Circuit Design Flow

FIGS. 4A and 4B illustrate different approaches to designing circuits. A typical design process might include generating a concept of what a circuit should do and determining desirable requirement(s) for the circuit, designing the circuit (e.g., generating an electronic schematic/circuit diagram), laying out/prototyping the circuit, testing the circuit, and potentially manufacturing the circuit. Furthermore, as indicated in both FIGS. 4A and 4B, it is often the case that the design process may include moving back and forth between the various stages of the design process, e.g., if a design improvement becomes apparent, or if one or more problems are identified that require reconsideration or modification of previous steps.

Conventionally, the stages of the design process have been approached as a sequential series of steps, such as shown in FIG. 4A. This serial approach has traditionally been necessary because, for example, it has not been possible to develop test conditions and applications until after a circuit has been prototyped.

Circuit design and simulation software (such as Multisim™ by National Instruments Corporation) offer a powerful set of tools for expanding and increasing the efficiency of circuit design. For example, circuit diagrams may be designed using circuit designer applications and simulated using circuit simulation applications. In some embodiments, a circuit simulation may essentially be considered a virtual prototype of a design; thus, even before a physical prototype circuit is built, its behavior may be modeled in a virtual environment. The various measurements that may be taken on a virtual circuit provide insight into how the circuit will perform when it is developed. Thus, design testing may be performed at an early stage, increasing the efficiency of the design process.

Of course, even though the characteristics of a virtual circuit may be measured and determined to meet the specification of a circuit concept, it will typically still be desirable to perform physical tests on a physical version of the circuit. However, as noted above, even with the ability to simulate a circuit to assist in the design process, it has traditionally not been possible to develop test conditions and applications until after a circuit has been prototyped.

The present disclosure thus relates to a system and method which may be used to generate test conditions and applications even before a circuit has been prototyped. Since a virtual circuit can be used as a good representation of the final prototype, it can in some embodiments be used as a surrogate for developing test applications. In other words, a simulated circuit, e.g., based on a circuit diagram, may be used as a virtual design under test (VDUT). By configuring a virtual instrumentation control system, a virtual test setup may potentially be developed in parallel with layout, as shown in FIG. 4B. According to some embodiments, test information that can be used to configure a physical test setup may then be generated from the virtual test setup. Thus, in some embodiments, it may be possible to develop a test system specifically configured to test a physical prototype before the physical prototype is actually created.

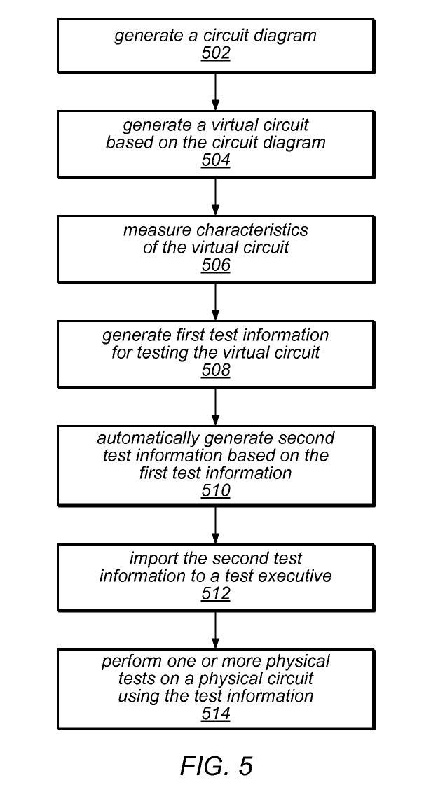

### FIG. 5—Flowchart Illustrating a Method for Generating Test Information for Testing a Circuit

FIG. 5 is a flowchart illustrating a method for generating test information for testing a circuit according to one embodiment. The method shown in FIG. 5 may be used in conjunction with any of the computer systems or devices shown in the above Figures, among other devices. For example, embodiments are contemplated in which the method described herein is used to generate test information to configure an instrumentation control system such as instrumentation control system 100 shown in FIG. 2. In various embodiments, some of the method elements shown may be performed concurrently, in a different order than shown, or may be omitted. Additional method elements may also be performed as desired. As shown, this method may operate as follows.

In 502, a circuit diagram may be generated, e.g., using a computer system. The circuit diagram may be designed by a user, e.g., using a circuit designer application, such as National Instruments' Multisim™, or any other circuit designer application. In other words, in some embodiments first user input specifying a circuit diagram may be received to a computer system, and the circuit diagram may be generated based on the user input.

In 504, a virtual circuit may be generated, e.g., using a computer system, based on the circuit diagram. The virtual circuit may be a simulation of the circuit represented by the circuit diagram. The virtual circuit may be generated by a circuit simulation application, e.g., in response to a user request to generate the virtual circuit. In some embodiments, the circuit simulation application may be the same application as the circuit designer application (e.g., National Instruments' Multisim™). In some embodiments, generating the virtual circuit may be performed concurrently with generating the circuit diagram; for example, a circuit designer application might simulate the circuit as it is designed by the user. Alternatively, the circuit designer application and the circuit simulation application may be different applications, if desired. For example, the circuit diagram could be generated using a first application and passed to a second application which could simulate the circuit.

In 506, characteristics of the virtual circuit may be measured, e.g., using a computer system. The characteristics of the virtual circuit may be measured using one or more virtual instruments, e.g., based on user input specifying that the one or more virtual instruments be used to measure characteristics of the virtual circuit. Measuring the characteristics of the virtual circuit may provide an indication of whether the virtual circuit performs according to its specification.

In some embodiments, the one or more virtual instruments may be software-based instruments that simulate physical instruments, e.g., that are capable of performing virtual functions on the virtual circuit that are equivalent to physical functions that could be performed on a physical circuit. For example, there might be one or more virtual PXI instruments that may be configured to perform measurements on or stimulate the virtual circuit in a similar manner as corresponding physical PXI instruments would perform measurements on or stimulate a physical circuit. More specifically, in some embodiments, one or more of the virtual instruments used to take measurements on or stimulate the virtual circuit may be configured to correspond to specific real world measurement instruments. Alternatively, or in addition, in some embodiments, one or more of the virtual instruments may include functionality for performing measurements on, and stimulating both virtual circuits and physical circuits; for example, some software-based instruments may include a mode for performing virtual measurements on or stimulating simulated devices (e.g., circuits), as well as a mode for performing physical measurements on or stimulating physical devices (e.g., circuits).

In 508, first test information for testing the virtual circuit may be generated. In some embodiments, the test information may be set by a user in a circuit simulation environment, e.g., on a computer system. In other words, the test information for testing the virtual circuit may be generated based on user input specifying part or all of the test information. For example, a user could configure one or more virtual instruments in the circuit simulation environment to perform one or more test steps (e.g., a test sequence, or part of a test sequence). The user might, for example, include one or more test conditions and/or instrument settings of the virtual instruments as at least part of the first test information. The test information may include any of various types of information according to various embodiments; for example, the test information might include one or more locations in the circuit at which test steps are to be performed, one or more types of tests that are to be performed, one or more limits for one or more test steps, and/or any other information, as desired. In other words, the test information may be used in configuring the virtual instrument(s) to perform one or more tests on the virtual circuit. Since, as noted above, in some embodiments the virtual instruments may be simulated analogs of physical instruments (or may also be capable of performing physical measurements or stimulating), the one or more tests on the virtual circuit may effectively correspond to physical tests that could be performed using the physical analogs of the virtual instrument(s) on a physical circuit.

In 510, second test information may be automatically generated based on the first test information. The second test information may be configured for use in performing one or more physical tests on a physical circuit corresponding to the virtual circuit. Thus, the second test information may also include one or more test conditions and/or instrument settings, and/or any other testing related information in the first test information, but may be adapted for use in performing physical measurements on or stimulating a physical circuit rather than performing virtual measurements on or stimulating a virtual circuit. For example, the one or more test conditions and/or instrument settings may be used to configure one or more physical instruments for use with the physical circuit corresponding to the virtual circuit. The second test information may be generated based on user input requesting that the second test information be automatically generated. The second test information may thus be generated automatically based on the first test information; in other words, generating the second test information may not require user input specifying the one or more test conditions and/or instrument settings, but may instead be generated based on the first test information.

Generating the second information may include exporting the test information to one or more files, in which the second test information may be stored. The file(s) may be any of various types of files; for example, the file(s) may be in a format configured for use by a test executive engine (such as National Instruments' TestStand™ or any other test executive engine), or an intermediate format that may later be converted to a format configured for use by a test executive engine. In various embodiments, the file(s) may be in ASCII, binary, or any other file format. Embodiments are also contemplated in which the output is usable by communications protocols including but not limited to TCP/IP, HTML, and web services; hardware platforms, including but not limited to MCUs and field programmable gate arrays (FPGAs); and/or programming environments including but not limited to National Instruments' LabVIEW™ and LabWindows™/CVI.

In 512, the second test information may be imported to a test executive. The test executive may use the second test information to perform one or more tests on a physical circuit corresponding to the virtual circuit. For example, the test executive may use the second test information to configure one or more instruments (e.g., any of the instruments shown in instrumentation control system 100 in FIG. 1) to perform one or more physical tests on the physical circuit. In some embodiments the one or more physical tests may be a series of test steps making up a test sequence. The one or more physical tests may thus be analogous to the virtual tests described above with respect to step 508.

In some embodiments, the second test information may be sufficient for the test executive to fully configure any instruments to be used in the tests and perform the one or more physical tests in their entirety. Alternatively, in some embodiments it may be necessary (or simply desirable) to add test steps, modify instrument configurations, or otherwise further configure the test executive before performing the one or more physical tests on the physical circuit.

In 514, the test executive may then perform (e.g., instruct the one or more instruments to perform) the one or more physical tests on the physical circuit using the second test information. Performing the one or more physical tests on the physical circuit may provide information regarding the functionality of the physical circuit. For example, performing the one or more physical tests may result in confirmation that the physical circuit meets the circuit specification, i.e., that the circuit functions as intended, or performing the one or more physical tests may result in an indication that one or more characteristics of the physical circuit do not meet the circuit specification, i.e., that the circuit does not function as intended.

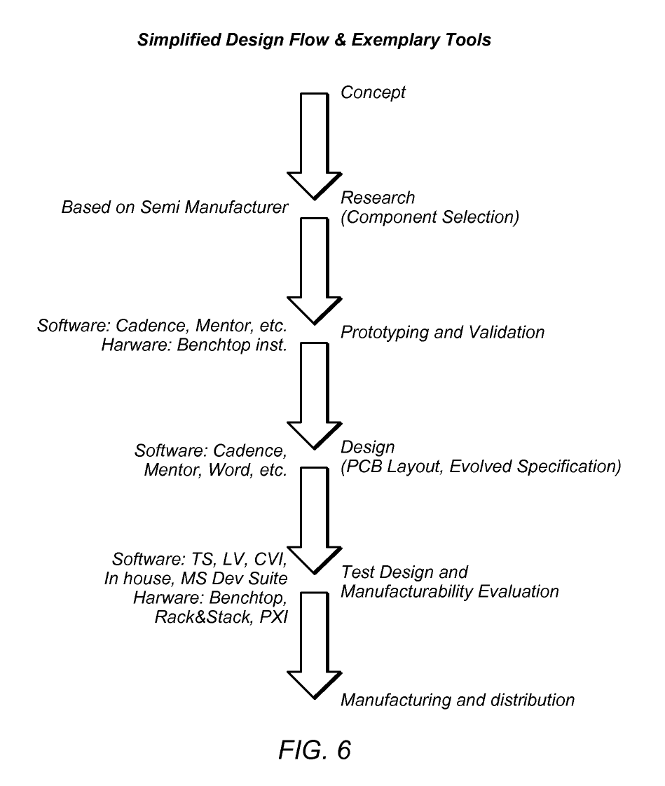

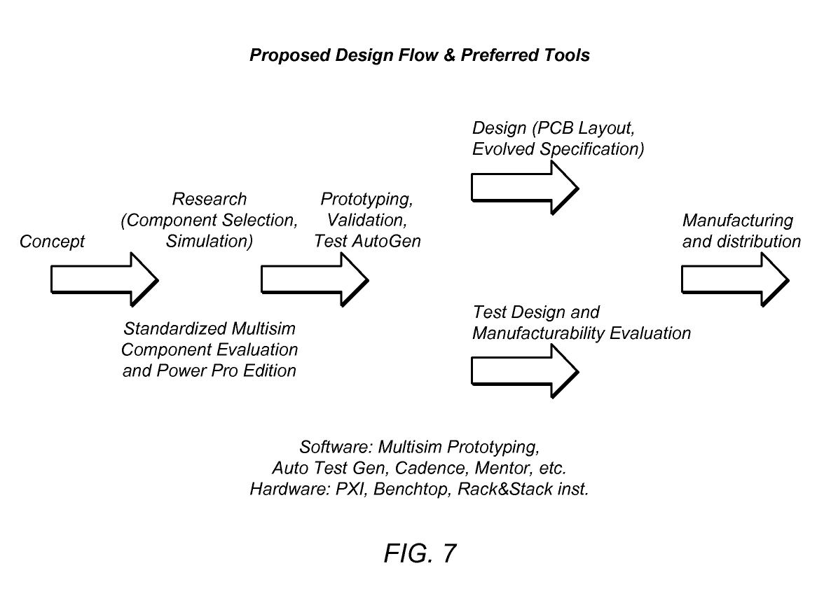

### FIGS. 6 and 7—Design Flow and Exemplary Tools

FIG. 6 illustrates serial circuit design flow and exemplary tools (e.g., software and/or hardware tools) that could be used for each step according to one embodiment. FIG. 7 illustrates a parallel circuit design flow and exemplary tools (e.g., software and/or hardware tools) that could be used for each step according to one embodiment.

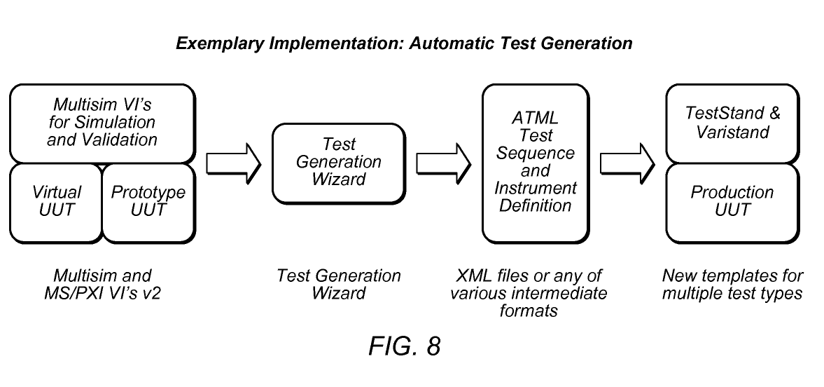

### FIG. 8—Exemplary Implementation

FIG. 8 illustrates an exemplary implementation of the circuit design process including automatic test information generation using various products from National Instruments Corporation. It will be noted that according to various embodiments, any of various other products may be used instead of or in addition to those shown in FIG. 8.

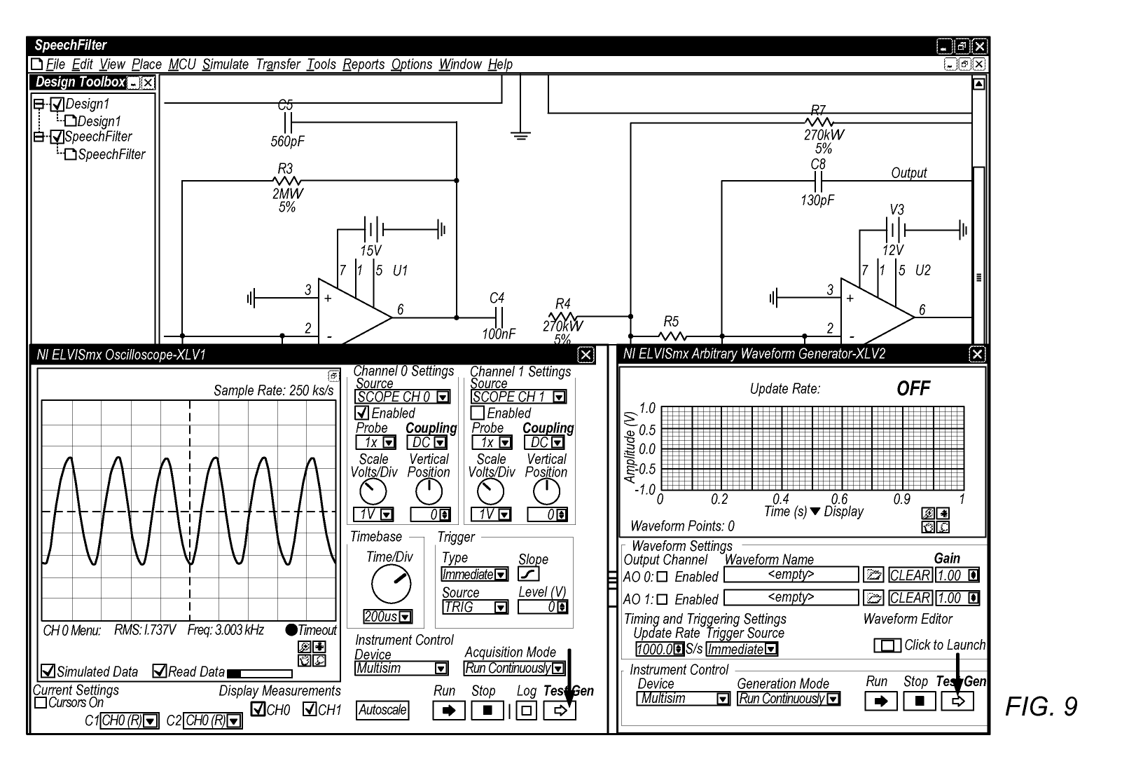

### FIGS. 9-11—Exemplary Screenshots and Test Executive and Associated Tools

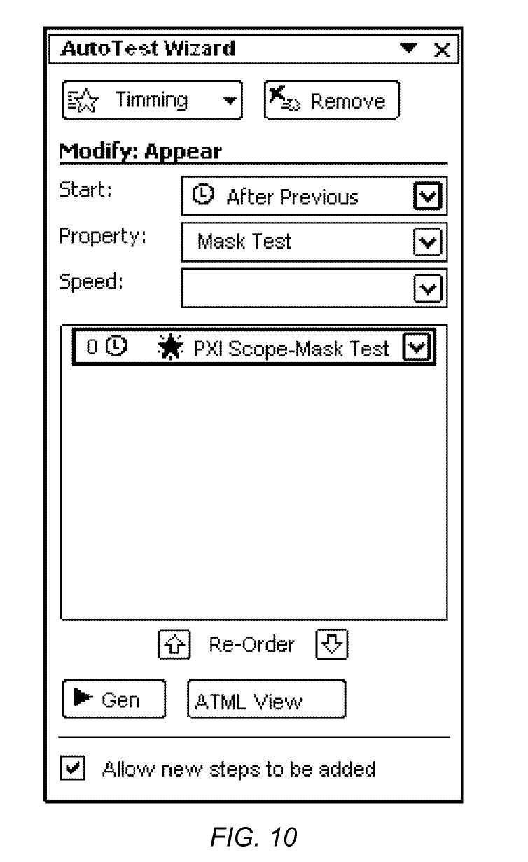

FIGS. 9 and 10 are exemplary screenshots illustrating a possible implementation for automatically generating test information for use in performing physical tests on a physical circuit from virtual tests on a virtual circuit. It should be noted that while the implementation illustrated in FIGS. 9 and 10 and described with respect thereto is an example of one possible implementation, other implementations are also contemplated; accordingly, limitations described with respect to this exemplary embodiment should not be considered limiting to the disclosure as a whole.

In the implementation shown, a user may generate test information for one or more virtual tests on a virtual circuit, e.g., using one or more virtual instruments. Each virtual instrument may include a “TestGen Wizard” button (indicated by the red arrows) shown in FIG. 9.

Pressing this button may bring up an “AutoTest Wizard” (FIG. 10) (e.g., a graphical user interface (GUI)), and may provide various information (such as the instrument setup information, simulation data, limits, and/or location in circuit information) to the wizard. The wizard may then add a test step to a (pre-existing or new) test sequence using some or all of the data provided by the virtual instrument. In some embodiments, a user may additionally be able to change the order of the sequence, add trimming information to the sequence, define a test type (such as limit, mask, pass/fail, etc.) for each step, and/or perform other functions with respect to the test sequence, using the wizard. The wizard may also be configured to generate test information for the test sequence in any of numerous formats (e.g., ATML, TestStand, Veristand™, any viable intermediate file format or communications protocol or environment, including another hardware or programming environment). In other words, the wizard may be used to automatically generate test information for use in performing physical tests on a physical circuit from the test information for the one or more virtual tests on the virtual circuit.

According to some embodiments, generating the test information for use in performing physical tests on a physical circuit may include generating whatever files are necessary to pass all the information generated to a test sequence. For example, in some embodiments, templates in National Instruments' LabVIEW™ or other programming language may be generated and used for specific test types (e.g., limit, mask, pass/fail, etc.). These may be available immediately, or may be hidden and a test sequence may be automatically generated in the test executive. Additionally, in some embodiments, the test sequence generated from the test information may be modified and/or augmented as desired.

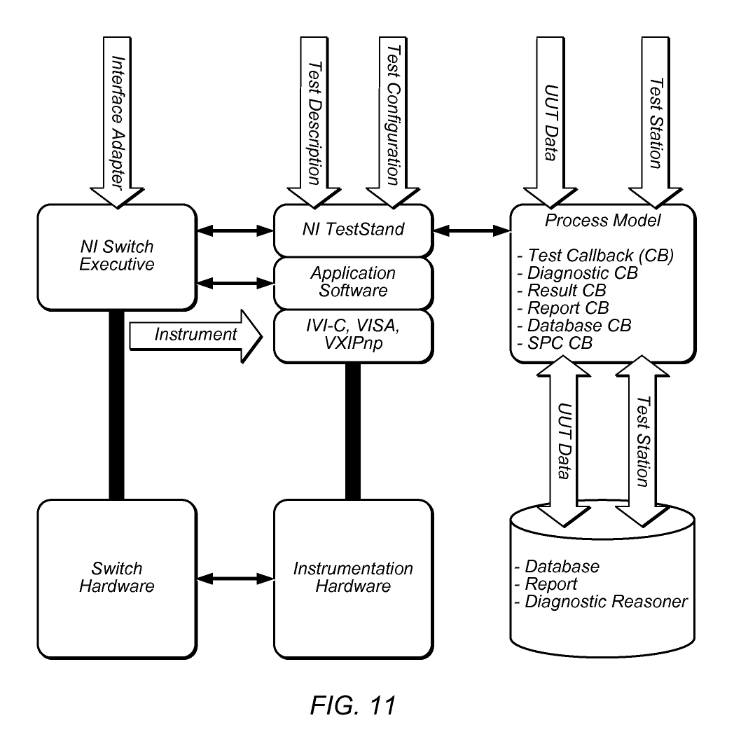

FIG. 11 illustrates an exemplary system architecture of a test executive and associated tools that may be used in accordance with the present disclosure according to some embodiments. It should be noted that while the architecture illustrated in FIG. 11 is an example of one possible architecture that could be used in accordance with embodiments of this disclosure, other implementations are also contemplated; accordingly, the disclosure as a whole should not be considered as being limited to this particular architecture. For example, it should be noted that although the test executive is shown in FIG. 11 as being National Instruments' TestStand™, any other test executive may be used if desired, according to various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-implemented method for generating test information for a physical circuit, the method comprising using a computer to perform:
generating a virtual circuit, wherein the virtual circuit comprises simulated characteristics of a physical circuit;
receiving first user input specifying one or more test conditions and/or instrument settings for the virtual circuit;
in response to the first user input, generating first test information, wherein the first test information comprises the one or more test conditions and/or instrument settings, wherein the first test information is configured for use in performing one or more virtual tests on the virtual circuit;
receiving second user input requesting that second test information be generated based on the first test information;
in response to the second user input, automatically generating second test information based on the first test information, wherein the second test information also comprises the one or more test conditions and/or instrument settings, wherein the second test information is automatically generated without user input specifying the one or more test conditions and/or instrument settings;
wherein the second test information is configured for use in performing one or more physical tests on a physical circuit corresponding to the virtual circuit.

2. The computer-implemented method of claim 1,
wherein at least a portion of the second test information is generated in a format configured for use by a test executive engine.

3. The computer-implemented method of claim 1,
wherein the second test information comprises a test sequence, the test sequence comprising a plurality of test steps.

4. The computer-implemented method of claim 1,
wherein the second test information is used to automatically configure one or more instruments to perform the one or more physical tests according to the one or more test conditions and/or instrument settings.

5. The computer-implemented method of claim 1,
wherein the second test information comprises information identifying one or more locations in the physical circuit at which the one or more physical tests are to be performed

6. The computer-implemented method of claim 1, further comprising:
performing, using the second test information, the one or more physical tests on the physical circuit corresponding to the virtual circuit.

7. The computer-implemented method of claim 1, further comprising:
performing, using the first test information, the one or more virtual tests on the virtual circuit, wherein the one or more virtual tests are performed by one or more virtual instruments utilizing the one or more test conditions and/or instrument settings.

8. A computer readable memory medium comprising program instructions for generating test information for a physical circuit, wherein the program instructions are executable to:
generate a virtual circuit, wherein the virtual circuit comprises simulated characteristics of a physical circuit;
receive first user input specifying one or more test conditions and/or instrument settings for the virtual circuit;
in response to the first user input, generate first test information, wherein the first test information comprises the one or more test conditions and/or instrument settings, wherein the first test information is configured for use in performing one or more virtual tests on the virtual circuit;
receive second user input requesting that second test information be generated based on the first test information;
in response to the second user input, automatically generate second test information based on the first test information, wherein the second test information also comprises the one or more test conditions and/or instrument settings, wherein the second test information is automatically generated without user input specifying the one or more test conditions and/or instrument settings;
wherein the second test information is configured for use in performing one or more physical tests on a physical circuit corresponding to the virtual circuit.

9. The computer readable memory medium of claim 8,
wherein at least a portion of the second test information is generated in a format configured for use by a test executive engine.

10. The computer readable memory medium of claim 8,
wherein the second test information comprises a test sequence, the test sequence comprising a plurality of test steps.

11. The computer readable memory medium of claim 8,
wherein the second test information is used to automatically configure one or more instruments to perform the one or more physical tests according to the one or more test conditions and/or instrument settings.

12. The computer readable memory medium of claim 8,
wherein the second test information comprises information identifying one or more locations in the physical circuit at which the one or more physical tests are to be performed

13. The computer readable memory medium of claim 8, wherein the program instructions are further executable to:
perform, using the second test information, the one or more physical tests on the physical circuit corresponding to the virtual circuit.

14. The computer readable memory medium of claim 8, wherein the program instructions are further executable to:
perform, using the first test information, the one or more virtual tests on the virtual circuit, wherein the one or more virtual tests are performed by one or more virtual instruments utilizing the one or more test conditions and/or instrument settings.

15. A system for generating test information for a physical circuit, the system comprising:
one or more processors;
a computer readable memory medium comprising program instructions, wherein the program instructions are executable by the one or more processors to:
generate a virtual circuit, wherein the virtual circuit comprises simulated characteristics of a physical circuit;
receive first user input specifying one or more test conditions and/or instrument settings for the virtual circuit;
in response to the first user input, generate first test information, wherein the first test information comprises the one or more test conditions and/or instrument settings, wherein the first test information is configured for use in performing one or more virtual tests on the virtual circuit;
receive second user input requesting that second test information be generated based on the first test information;
in response to the second user input, automatically generate second test information based on the first test information, wherein the second test information also comprises the one or more test conditions and/or instrument settings, wherein the second test information is automatically generated without user input specifying the one or more test conditions and/or instrument settings;
wherein the second test information is configured for use in performing one or more physical tests on a physical circuit corresponding to the virtual circuit.

16. The system of claim 15,
wherein at least a portion of the second test information is generated in a format configured for use by a test executive engine.

17. The system of claim 15,
wherein the second test information comprises a test sequence, the test sequence comprising a plurality of test steps.

18. The system of claim 15,
wherein the second test information is used to automatically configure one or more instruments to perform the one or more physical tests according to the one or more test conditions and/or instrument settings.

19. The system of claim 15,
wherein the second test information comprises information identifying one or more locations in the physical circuit at which the one or more physical tests are to be performed

20. The system of claim 15, wherein the program instructions are further executable by the one or more processors to:
perform, using the second test information, the one or more physical tests on the physical circuit corresponding to the virtual circuit.
